(19) United States
(12) Patent Application Publication
(10) Pub. No.: US 2019/0286970 A1
(43) Pub. Date: Sep. 19, 2019

(54) REPRESENTATIONS OF UNITS IN NEURAL NETWORKS

(71) Applicant: Uber Technologies, Inc., San Francisco, CA (US)

(72) Inventors: Theofanis Karaletsos, San Francisco, CA (US); Peter Dayan, London (GB); Zoubin Ghahramani, Cambridge (GB)

(21) Appl. No.: 16/356,991

(22) Filed: Mar. 18, 2019

Related U.S. Application Data
(60) Provisional application No. 62/644,381, filed on Mar. 17, 2018.

(51) Int. Cl. G06N 3/04; G06N 7/00

(52) U.S. Cl. CPC G06N 3/0472; G06N 7/00

(57) ABSTRACT

A trained computer model includes a direct network and an indirect network. The indirect network generates a set of weights or a set of weight distributions for the nodes and layers of the direct network. The direct network includes units associated with unit codes representative of the unit's structural position in the direct network. Weight codes are determined for weights of the direct network based on unit codes associated with units connected by the weights. The indirect network generates the set of weights or set of weight distributions based on weight codes associated with weights of the direct network.

### CROSS REFERENCE TO RELATED APPLICATIONS

This application claims the benefit of U.S. Provisional Application No. 62/644,381, filed Mar. 17, 2018, which is incorporated by reference in its entirety.

### BACKGROUND

This specification relates generally to machine learning and more specifically to training systems such as neural networks.

Computer models, such as neural networks, learn mappings between a set of inputs to a set of outputs according to a function. In the case of a neural network, each p element (also called a node or hidden element) may apply its own function according to a set of weights for the function for the processing element. The mapping is considered a “direct” mapping, representing a function that translates the set of inputs to a set of outputs. The mapping is represented by a set of weights for the function to translate the inputs to the outputs. Many problems in machine learning, statistics, data science, pattern recognition, and artificial intelligence involve the representation and learning of mappings. A mapping is a transformation that, for example, may map from images to images for de-noising, from images to the labels of the objects in the images, from English sentences to French sentences, from states of a game to actions required to win the game, or from vehicle sensors to driving actions. In general, both the input to a mapping and the output of the mapping are represented as digitally-encoded arrays.

A function ƒ maps an input x to an output y. Thus we have the following as a general expression of the idea that function ƒ maps input x (e.g., an image of a cat, digitally represented as an array of pixels) to output y (e.g., the label “cat” as a word):

y=ƒ(x) Equation 1

Such mappings may be represented with artificial neural networks which transform the input x to the output y via a sequence of simple mathematical operations involving summing inputs and nonlinear transformations. Mappings employed in machine learning, statistics, data science, pattern recognition, and artificial intelligence may be defined in terms of a collection of parameters, also termed weights w for performing the mapping. The weights w define the parameters of such a mapping, e.g., y=ƒ(x,w). In a neutral network, these parameters reflect weights accorded to different inputs x to the function ƒ or parameters of the function itself to generate the output of the network. Though the network as a whole may be considered to have weights, individual nodes (or “hidden units”) of the network each individually operate on a set of inputs to generate an output for that node according to weights of that node.

Neural network architectures commonly have layers, where the overall mapping of the neural network is composed of the composition of the mapping in each layer through the nodes of each layer. Thus the mapping of an L layer neural network can be written as follows:

y=ƒ(x)=ƒ_{L}(ƒ_{L-1} . . . (ƒ₁(x)))) Equation 2

where f denotes the mapping computed by the Lth layer. In other words, the initial input undergoes successive transformations by each layer into a new array of values.

Referring to FIG. 1, an exemplary neural network 100 is illustrated. As shown, the network 100 comprises an input layer 110, an output layer 150 and one hidden layer 130. In this example, the input layer is a 2-dimensional matrix having lengths P×P, and the output layer 150 is a 2-dimensional matrix having lengths Q×Q. For each processing layer, a set of inputs x to the layer are processed by nodes of the layer according to a function ƒ with weights w to outputs y of the layer. The outputs of each layer may then become inputs to a subsequent layer. The set of inputs x at each layer may thus be a single value, an array, vector, or matrix of values, and the set of outputs y at each layer may also be a single value, an array, vector, or matrix of values. Thus, in this example, an input node 111 in the input layer 110 represents a value from a data input to the network, a hidden node 131 in the hidden layer 130 represents a value generated by the weights 121 for node 131 in the hidden layer applied to the input layer 110, and output node 151 represents an output value 151 from the network 100 generated by weights 141 for the node 151 applied to the hidden layer 130.

Although the weights are not individually designated in FIG. 1, each node in a layer may include its own set of weights for processing the values of the previous layer (e.g., the inputs to that node). Each node thus represents some function ƒ, usually nonlinear transformations in each layer of the mapping, with associated weights w. In this example of a mapping the parameters w correspond to the collection of weights {w(1), . . . , w(L)} defining the mapping, each being a matrix of weights for each layer. The weights may also be defined at a per-node or per-network level (e.g. where each layer has an associated matrix for its nodes).

During training, the weights w are learned from a training data set D of N examples of pairs of x and y observations, D={(x₁, y₁) . . . , (x_{N}, y_{N})}. The goal of the network is to learn a function ƒ through the layers of the network that approximate the mapping of inputs to outputs in the training set D and also generalize well to unseen test data Dₜₑₛₜ.

To learn the weights for the network and thereby more accurately learn the mapping, an error or loss function, E(w, D) evaluates a loss function L which measures the quality or the misfit of the generated outputs ŷ to the true output values y. One example error function may use a Euclidian norm:

E(w, D)= [symbol] (y, ƒ(x; w))= [symbol] (y, ŷ)=∥y−ŷ∥². Equation 3

Such an error function E can be minimized by starting from some initial parameter values (e.g., weights w), and then evaluating partial derivatives of E(w, D) with respect to the weights w and changing w in the direction given by these derivatives, a procedure called the steepest descent optimization algorithm.

$${w}_{t} ← {w}_{t - 1} - {η}_{t} \frac{\partial E ( w , D )}{\partial w} {\vert}_{{w}_{t - 1}} , \qquad Equation 4$$

Various optimization algorithms may be used for adjusting the weights w according to the error function E, such as stochastic gradients, variable adaptive step-sizes, second-order derivatives or approximations thereof, etc. Likewise, the error function E may also be modified to include various additional terms.

Learning of direct weights can be impacted by initial data sets (or batches) that train the date, and different weights may result from and be suggested by different data set orders. Systems which rigorously result in a single set of weights for the network may fail to account for these different weight sets, and be rigid and inflexible, failing to generalize well or account for missing data in an input to the network as a whole.

### SUMMARY

A direct mapping for a network is learned in conjunction with an indirect network that designates weights for the direct mapping. The network generating the direct mapping may also be termed a “direct network” or a “direct model.” The direct network may be a portion of a larger modeled network, such as a multi-node, multi-layered neural network. The indirect network learns a weight distribution of the weights of the direct network based on unit codes that may represent structural positions of the weights within the direct network. In particular, a weight in the direct network that connects nodes in the direct network may be determined by the indirect network based on unit codes associated with the nodes connected by the weight. The indirect network may also be termed an “indirect model.”

In one embodiment, the weights are probabilistic weight distributions. The indirect model generates a weight distribution for the direct model based on a set of indirect parameters that affect how the indirect network models the direct network weights. In addition, the indirect model receives an input describing characteristics of weights of the direct model, such as the structural position of a weight within the direct network. In one embodiment, weights of the direct network are determined in the indirect network from weight codes associated with the weights. The weight codes are based on unit codes representative of structural positions of units within the direct network. For example, unit codes are determined for units of the direct network based on a layer and index of each unit. This indirect model may thus generate weights that capture correlations within the direct network to represent more complicated networks.

In an embodiment, the unit codes are latent representations learned during training. Rather than unit codes defined by a fixed value of the structural position of the corresponding unit (e.g., the associated node's position in the network), when unit codes are latent representations the value of the unit codes are inferred from the performance of latent representations (in combination with parameters for the direct network) in generating successful weights for the direct network. Latent representations allow the indirect network to generate weights that reflect correlations between units and weights that are not represented by the structure of the direct network.

The indirect model may receive components as input in addition to the unit codes, such as a latent state variable that may be learned during training. The latent state variable may reflect different tasks for which the direct network is used.

In further embodiments, the indirect network generates a set of weights for the direct network as probabilistic distributions. The probabilistic distributions are used to effectively ‘simulate’ many possible sets of weights according to the possible distribution or by evaluating as the mean of the sample outputs. The probabilistic distributions are applied by sampling from multiple points in the distribution of the weights and determining a resulting output for the direct network based on each sampled set of weights. The different samples are then combined according to the probability of the samples to generate the output of the direct network. Because the indirect network may learn the weights of the direct network as a distribution of ‘possible’ weights, the indirect network may more consistently learn the sets of weights of the direct network and overreliance on initial training data or bias due to the ordering in which the training data is batched; the different direct network weights as encouraged by different sets of training data may now be effectively captured as different distributions of these weights in the direct weight distribution.

To train the expected distribution of weights for the direct network, an input is evaluated according to the expected prior weight distribution, and a loss function is used to evaluate updates to the distribution based on error to the data term generated from the prior weight distribution and error for an updated weight distribution. The loss function is used to update the expected prior distribution of direct weights and accordingly update the indirect parameters.

Using the indirect network to generate a weight distribution for the direct model provides many advantages in the training and use of the direct network. By using unit codes that characterize weights of the direct network according to the units connected by the weights, the indirect network generates weights that are able to express correlations or couplings between units of the direct network. Additionally, because the indirect network avoids direct encoding of weights as in conventional network structures, the use of unit codes to generate weights for direct networks requires a more compact network and may operate on more limited training data.

Additionally, the indirect network aids in the generation of transfer learning for different tasks. Since the indirect network predicts general expected characteristics of a network, the parameters for the indirect network may be used as initial expected parameters for training additional direct networks for different tasks. In this example, the indirect network may be used to initialize the weights for another direct network. In addition, when designating a domain as a control parameter, either with or without latent state variables, the new domain may readily be incorporated by the control parameters for the indirect network (e.g., as a state variable or parameter) because the training for the new domain may only require learning the differences from the prior domain while re-using the previously-learned aspects of the initial domain. In addition, the latent state variables may define known properties or parameters of the environment in which the direct network is applied, and changes to those properties may be used to learn other data sets having other properties simply by designating the properties of the other data sets when learning the new data sets. In other examples, the indirect network jointly trained with multiple direct networks, permitting the indirect network to learn more general ‘rules’ for the direct networks and reflect an underlying or joint layer for the direct networks.

### BRIEF DESCRIPTION OF THE DRAWINGS

FIG. 1 illustrates an exemplary neural network.

FIG. 2 illustrates a computer model that includes a direct network and an indirect network according to one embodiment.

FIG. 3 illustrates a process for generating a set of weights for a direct network using weight codes of the direct network, according to one embodiment.

FIGS. 4A-4B illustrate examples of determining weight codes for weights of a direct network based on corresponding unit codes, according to one embodiment.

FIG. 5 is a flow diagram of a method for generating weights for a direct network using weight codes of the direct network, according to one embodiment.

FIG. 6 is a high-level block diagram illustrating physical components of a computer used to train or apply direct and indirect networks, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

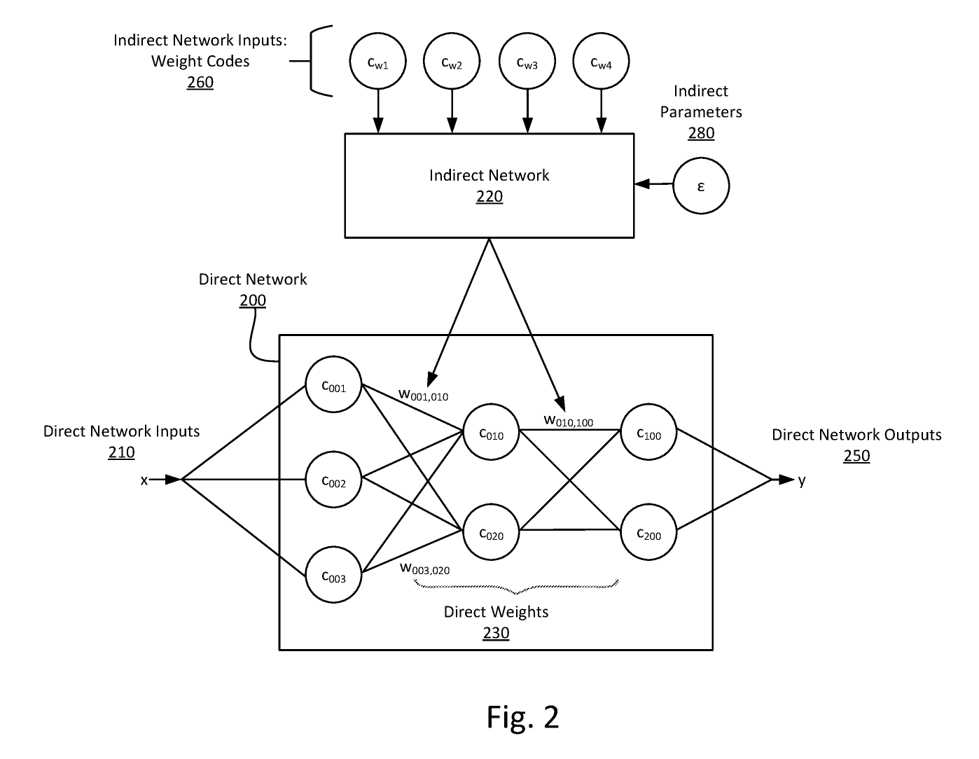

FIG. 2 illustrates a computer model that includes a direct network and an indirect network, according to one embodiment. In this example, the computer model refers to the learned networks trained on a data set D having inputs x and associated outputs y. These inputs and outputs thus represent data input and related data output of the dataset. In that sense, the modeling learns to generate a predicted output y from an input x.

As discussed more fully below, this computer model may include a direct network 200 and an indirect network 220. During training, the computer model may include both the direct network 200 and the indirect network 220. As discussed more fully below, the trained network itself may be applied in one example to unknown data with only the direct network 200 and its weights, while in another example the trained network may be applied to new data with the indirect network 220 and the structure of the direct network using predicted weights predicted an indirect network.

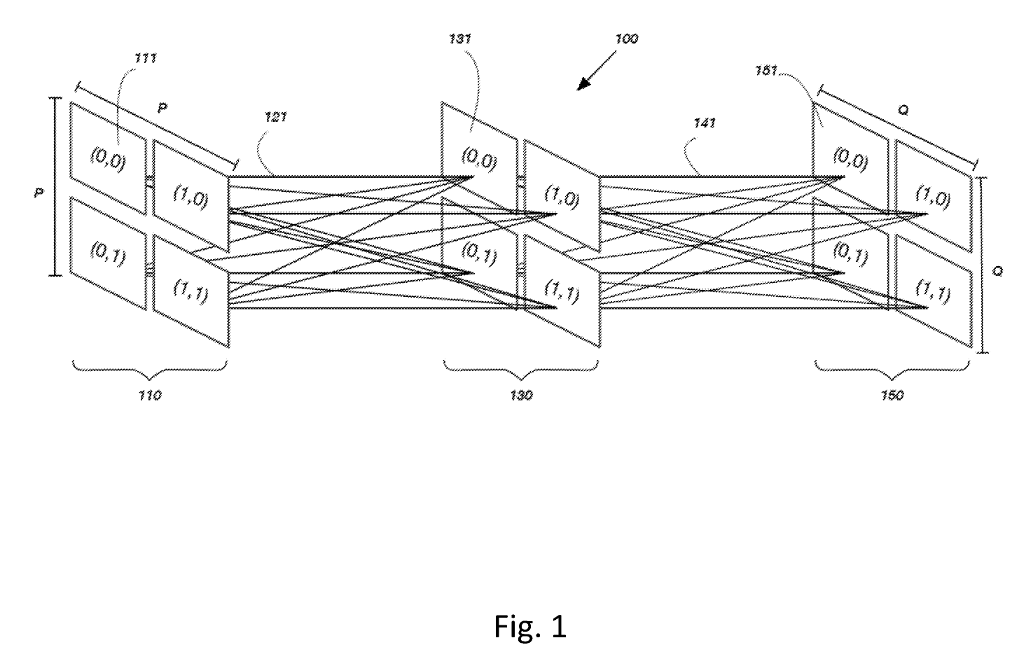

The direct network 200 implements a function ƒ for mapping a set of direct inputs x 210 to a set of direct outputs y 250. As discussed above with respect to FIG. 1, the mapping of the direct inputs x to direct outputs y may be evaluated by applying direct weights w to the various nodes, or “units.” In this example, three layers are illustrated in which the direct outputs y 250 are generated by applying direct weights w to the direct inputs 210. In other examples, the direct network 200 may include fewer or additional layers. For example, a direct input 210 may be used to generate one or more direct outputs 250, the one or more direct outputs based on the direct weights w connecting the units of the direct network 200.

In the example of FIG. 2, the direct network 200 includes a unit code for each unit of the direct network. In one embodiment, the unit codes c are determined based at least in part on a structural position of the corresponding units within the direct network 200. For example, a unit code c identifies a layer L of the neural network associated with the unit and an index i, j of the unit within the layer L. Unit codes are used to determine weight codes w for weights connecting pairs of units. A weight connecting a pair of units reflects some function for combining values of nodes in a next layer of the neural network. For example, a weight code c_{w1} for weight w_{001,010} connecting units associated with unit codes c₀₀₁ and c₀₁₀ is determined by concatenating the unit codes c₀₀₁ and c₀₁₀. In other examples, other methods for determining weight codes may be used, such as additively or multiplicatively combining unit codes values, performing one or more operations on the unit codes, inputting unit codes to a fixed mathematical function, or other methods in which pairs of unit codes are combined.

As shown in FIG. 1, the direct network 200 is termed a “direct” network because its weights “directly” generate data outputs from data inputs for the data set D being trained for the network. Put another way, the data input to the network model is entered as an initial layer of the direct network 200, and the output of the direct network is the desired output of the network model itself. Thus, for the training data D, its input x is provided as the direct inputs 210, and training is expected to result in the values of direct outputs 250 matching the training data's associated output y.

The indirect network 220 generates a set of weights W for the direct weights 230 of the direct network 200. The set of weights W describes possible values of the weights of the direct network 200 and probabilities associated with the possible values. In this way, the set of weights W may also be considered to model a statistical prior of the direct weights and captures a belief about the distribution of the set of weights and may describe the dependence of each weight on the other weights. The set of weights W may describe the possible values and associated probabilities as a function or as discrete values. As a result, rather than directly describing the function applied to the input x to generate the output y for a given set of weights in the direct network 200, the indirect network 220 describes the weights themselves of the direct network.

The indirect network 220 is a learned computing network, and typically may be a neural network or other trainable system to output set of weights W of the direct network 200. To parameterize the generation of the set of weights W, the indirect network 220 may use a set of indirect parameters ε 280 designating how to apply the functions of the indirect network in generating the set of weights W of the direct network 200. In addition, the indirect network 220 receives a set of weight codes c_{w} 260 that describe how to apply the indirect network to generate the set of weights. These weight codes c_{w} 260 serve as an “input” to the indirect network 220, and provide an analog in the indirect network for the inputs x of the direct network 200. Stated another way, the indirect network 220 provides a function g that outputs the expected weight distribution W as a function of the indirect parameters ε 280 and the weight codes c_{w} 260. As a general formula, g (W|c_{w}, ε).

In an embodiment, the set of weights W may take several forms according to the type of indirect network 220 and the resulting parameters generated by the indirect network. The set of weights W may follow various patterns or types, such as a Gaussian or other probabilistic distribution of the direct weights, and may be represented as a mixture model, multi-modal Gaussian, density function, a function fit from a histogram, any (normalized and unnormalized) implicit distribution resulting from draws of stochastic function and so forth. Accordingly, the set of weights W describes various sets of weights for the direct network 200 and the relative likelihood of the different possible sets of weights. As one example, the set of weights W may reflect a Gaussian or normal distribution of the direct weights, having a mean, standard deviation, and a variance. The set of weights W may independently describe a distribution of each weight w, or may describe a multi-variate distribution of more than one direct weight w together.

The indirect network 220 may be structured as various types of networks or models. Though termed a network, the indirect network 220 may include alternate types of trainable models that generate the set of weights W. Thus, the indirect network 220 may include multivariate or univariate models. The indirect network 220 may be a parametric model or neural network, but may also apply to nonparametric models, such as kernel functions or Gaussian Processes, Mixture Density Networks, nearest neighbor techniques, lookup tables, decision trees, regression trees, point processes, and so forth. In general, various types of models may be used as the indirect network 220 that effectively characterize the expected weight distribution and have indirect parameters 280 that may be trained from errors in the output y predicted by the direct network 200.

The weight codes c_{w} describe characteristics that may condition the generation of the expected weight distribution W of the direct network 200. In some embodiments, the weight codes c_{w} are determined based on unit codes of units connected by the weights w. In other embodiments, the weight codes c_{w} may incorporate additional components describing other characteristics of the direct network 200. These characteristics may describe various relevant information, for example describing a particular computing element or node of a larger network, a layer of the network, designate a portion of an input operated on by a given direct network 200, a source of a data set, characteristics of a model or environment for the data set, or a domain or function of the data set. As an example of a portion of an input, for an image or video input, different portions of the input may be separately processed, for example when the direct network 200 performs a convolution or applies a kernel to the portion of the input.

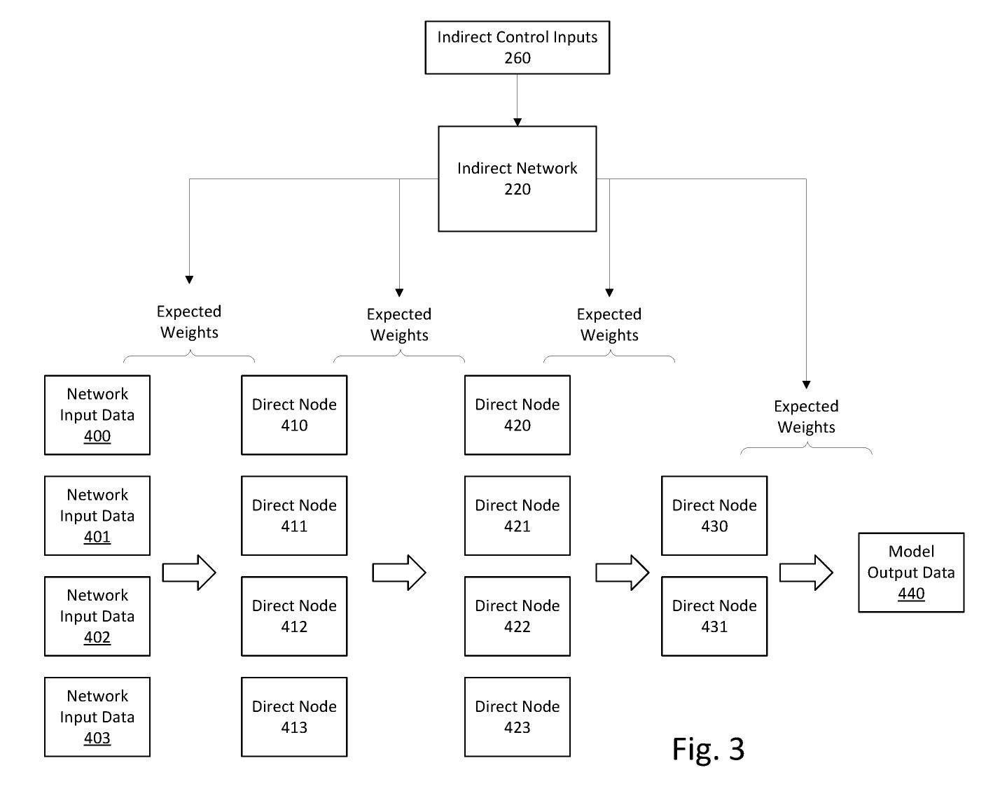

FIG. 3 illustrates an indirect network for a plurality of direct network layers, according to one embodiment. In this example, the indirect network 220 generates expected weight distributions for nodes of the network model. In this example, the expected weight distributions may be generated for each separate layer or for each node within a layer. In this example, the network model includes several layers in which each layer includes one or more nodes. In this example, the initial data inputs are entered at an initial network input data layer 400-403, and are initially processed by a layer of direct nodes 410-413. The output of these direct nodes 410-413 are used as inputs to the next layer of direct nodes 420-423, which is used as an input to the direct nodes 430-431, and finally as inputs to a model output data node 440. With respect to each layer or each node, the “direct network” as shown in FIG. 2 may represent a single layer or node in the larger model, such that the expected weight distribution generated by the indirect network 220 are generated to account with respect to the inputs and outputs of that particular layer. To generate the expected weight for a pair of connected nodes, a weight code 260 specifying the layers and indices for each node of the pair of connected nodes is used as an input to the indirect network 220. Likewise, when training the indirect network, the error in expected weights may be propagated to the indirect network 220 and specify to which weight codes 260 (the particular connected nodes) the error is associated. By setting the weight codes 260 to account for the location of the node within the network, the indirect network 220 may learn, through the weight codes and indirect parameters, how to account for the more general ways in which the weights differ across the larger network of weights being generated by the indirect network.

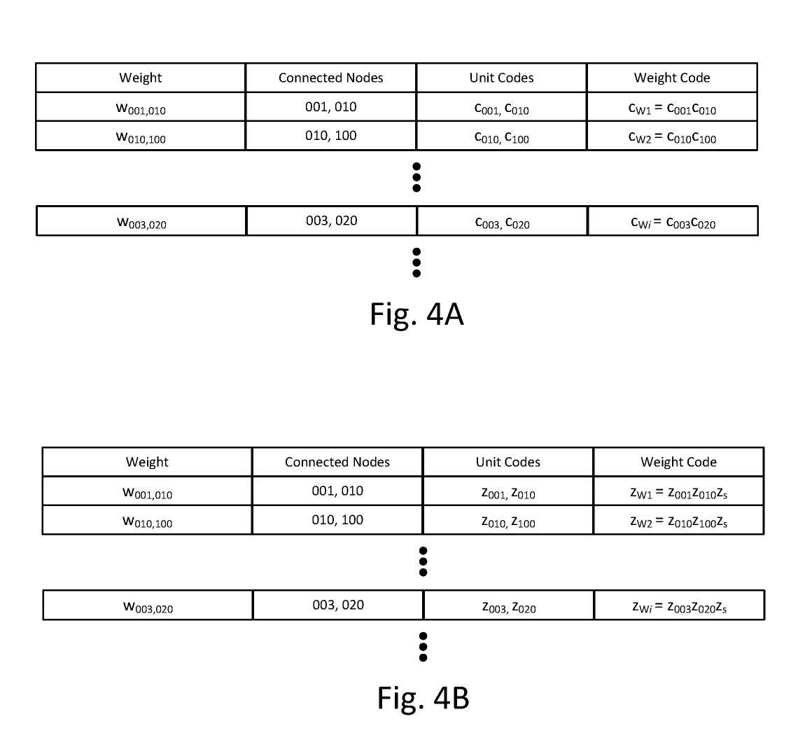

FIGS. 4A-4B illustrate examples of determining weight codes for weights of a direct network based on corresponding unit codes, according to an embodiment. FIG. 4A illustrates an example for determining weight codes using a fixed function based on unit codes associated with units connected by weights of the direct network 200. Each weight in the set of weights for the direct network 200 is associated with a pair of nodes connected by the weight. As an example shown in FIG. 4A, a weight w_{001,010} connects nodes 001 and 010. The connected nodes 001 and 010 are associated with unit codes cool and cow respectively, which in this example are determined as a function of the structural position of the associated unit. For example, the unit code may be a function concatenating the layer and index of the unit such that for node 001 the unit code c₀₀₁ is 001, reflecting the position of node 001 at layer 0, index (0,1). In this embodiment, the weight code c_{w1} is determined as a concatenation of the corresponding unit codes, as per equation 5. In other embodiments, other methods of determining the weight code based on the corresponding unit codes may be used, such as additively or multiplicatively combining unit codes values, performing one or more operations on the unit codes, inputting unit codes to a fixed mathematical function, or other methods in which pairs of unit codes are combined.

c_{w}(l,i,j)=[c_{L,i},c_{l-1,j}]. Equation 5

Weight codes c_{w} are determined as a function of (l, i,j) for each weight of a direct network 200 to generate a set of weight codes C. The set of weight codes C is then used as an input to the indirect network 220 alongside parameters ε to generate a set of weights for the direct network 200. In one embodiment, the set of weights W is determined by maximizing a probability P for the set of weights being correct (with respect to the evaluation of input x to output y) for a given set of weight codes C and indirect parameters ε, as shown in equation 6.

$$P ( W \vert C ; ξ ) = {\prod }_{l = 1}^{L} {\prod }_{i = 1}^{{V}_{l}} {\prod }_{j = 1}^{{V}_{l - 1}} P ( {w}_{l , i , j} \vert {c}_{w} ( l , i , j ) ; ξ ) . \qquad Equation 6$$

Equation 6 is a function for maximizing the probability P(W|C; ε). For a direct network 200 with L layers wherein each layer has dimensions up to i×j, the indirect network 220 maximizes the probability P for each weight w_{l,i,j} based on a corresponding weight code c_{w}(l,i,j) and the indirect parameters ε. The set of weights W is applied to the direct network 200. In an embodiment, the set of weights W determined by the indirect network 220 is used by the direct network 200 during training to identify an error between an expected output and the output of the direct network based on the weights W. The identified error may be used to update the set of weights of the direct network 200 and the indirect parameters ε, such that future iterations produce more accurate weights and parameters based on the error.

FIG. 4B illustrates an example for determining weight codes using latent codes that represent nodes of a direct network. In this example, the input code z_{w} for a given direct network 200 may be inferred (e.g., learned) from the training data in conjunction with the different indirect parameters ε suggested by the various training data. By permitting the control input to represent an unknown or hidden state of each node, variations in the input data may be used to learn a most likely set of indirect inputs. This allows nodes to be represented by more flexibly learned representations instead of fixed structural codes.

For a given weight w_{001,010} connecting units 001 and 010, a weight code is determined from unit codes associated with the units 001 and 010. The connected units 001 and 010 are associated with unit codes z₀₀₁ and z₀₁₀ respectively, wherein the unit codes are latent representations (e.g., not fixed) of the units within the direct network 200. In one embodiment, the latent unit codes are initialized as a function of the layer and index of the units, and are adjusted in training the indirect network 220. As discussed in conjunction with FIG. 4A, the weight code z_{w1} is determined as a concatenation of the corresponding unit codes z₀₀₁z₀₁₀.

As described in conjunction with FIG. 4A, the weight codes z_{w} are used as an input to the indirect network 220 alongside parameters ε to generate a set of weights for the direct network 200. The indirect network 200 maximizes the probability P for the set of weights W being correct for a given set of latent weight codes Z and indirect parameters ε, as shown in equation 7.

$$\begin{matrix}P ( W \vert Z ) = {\prod }_{l = 1}^{L} {\prod }_{i = 1}^{{V}_{l}} {\prod }_{j = 1}^{{V}_{l - 1}} P ( {w}_{l , i , j} \vert {c}_{w} ( l , i , j ) ; ξ ) \\ = {\prod }_{l = 1}^{L} {\prod }_{i = 1}^{{V}_{l}} {\prod }_{j = 1}^{{V}_{l - 1}} P ( {w}_{l , i , j} \vert [ {z}_{l , i} , {z}_{i - 1 , j} ] ; ξ )\end{matrix} \qquad Equation 7$$

Equation 7 is a function for maximizing the probability P (W|Z). As discussed in conjunction with equation 6, the indirect network 220 receives a set of latent weight codes W for a direct network 200 with L layers wherein each layer has dimensions up to i×j. The indirect network 220 additionally receives a set of indirect parameters ε. The indirect network 220 generates a set of weights for the direct network 200 by maximizing the probability of a weight w_{l,i,j} based on the corresponding latent unit codes connected by the weight z_{l,i} and z_{l-1,j} and the indirect parameters ε. The generated set of weights W is applied to the direct network 200.

FIG. 4B additionally illustrates an example for determining weight codes including a global latent state variable zₛ. The use of a global latent state variable allows the indirect network 220 to generate a set of weights W for the direct network 200 incorporating longer-range correlations across all the weights in the network. Additionally, the use of a global latent state variable zₛ aids in the use of the indirect network 220 for transfer learning. For example, the indirect network 220 generates a set of weights W₁ for a first direct network with a global latent state variable zₛ₁ and a first set of training data. The indirect network 220 generates a set of weights W₂ second direct network performing a related task to the first direct network using the first set of training data and a global latent state variable zₛ₂. In an embodiment wherein a global latent state variable zₛ is determined for the direct network 200, a weight code w_{001,010} is determined by performing a concatenation on the corresponding unit codes z₀₀₁ and z₀₁₀ and the latent state variable zₛ, such that the weight code z_{w1} is z₀₀₁z₀₁₀zₛ.

$$P ( W \vert Z , {z}_{s} ) = {\prod }_{l = 1}^{L} {\prod }_{i = 1}^{{V}_{l}} {\prod }_{j = 1}^{{V}_{l - 1}} P ( {w}_{l , i , j} \vert [ {z}_{l , i} , {z}_{i - 1 , j} ] , {z}_{s} ; ξ ) \qquad Equation 8$$

Equation 8 modifies the previous equation 7 for maximizing the probability P(W|Z) to incorporate a global latent state variable zₛ. Accordingly, equation 8 is directed to maximizing a probability P(W|Z, zₛ) of a set of weights being correct based on a set of latent weight units Z and a global latent state variable zₛ. The indirect network 220 receives, in addition to a set of latent unit codes z_{l,i} and z_{l-1,j} and the indirect parameters ε, a global latent state variable zₛ. In the embodiment as shown, the global latent state variable zₛ is an unfixed value learned in parallel with the set of direct weighs W and the indirect parameters ε. In other embodiments, the global state variable zₛ is a fixed value determined for the direct network 200.

In one embodiment, one or more of the unit codes, the weight codes, the global latent state variable, the indirect parameters ε, and the weights generated by the indirect network 220 are probabilistic distributions. In an example where the weights are probabilistic distributions, rather than designating a specific weight set for the direct network 200, the weight distribution is used to model the possible weights for the direct network. To evaluate the direct network 200, rather than use a specific set of weights w, various possible weights are evaluated and the results combined to make an ultimate prediction by the weight distribution as a whole when applied to the direct network, effectively creating an ensemble of networks which form a joint predictive distribution. Conceptually, the generated output ŷ is evaluated as the most-likely value of y given the expected distribution of the weight sets. Formally, ŷ may be represented as an integral over the likelihood given an input and the expected weight distribution. The direct network output ŷ may also be considered as a Bayesian Inference over the expected weight distribution, which may be considered a posterior distribution for the weights (since the expected weight distribution is a function of training from an observed dataset). In training, the indirect parameters ε may be learned from an error of the expected weight distribution, for example by Type-II maximum likelihood.

In one example, the integration averages over all possible solutions for the output y weighted by the individual posterior probabilities of the weights and thus may result in a better-calibrated and more reliable measure of uncertainty in the predictions. Stated another way, this inference may determine a value of output y as a probability function based on the direct network input x, the latent codes z, and the indirect parameters c or more formally: P (ŷ|x, z, ε). In performing an integration across the probable values of y, the uncertainty of the direct weights is explicitly accounted for in the expected weight distribution, which allows inferring complex models from little data and more formally accounts for model misspecification.

Since an integration across the expected weight distribution may often be implausible, in practice, the direct network output y may be evaluated by sampling a plurality of weight sets from the distribution and applying the direct network 200 to the sampled weight sets.

$$\begin{matrix}P ( y \vert x ) = {\int }_{z} P ( Z ) {\int }_{w} P ( y \vert x , W ) P ( W \vert Z ) dWdZ & Equation 9 \\ P ( Z ) = {\prod }_{l , i} P ( {z}_{l , i} ) = {\prod }_{l , i} 𝒩 ( 0 , 1 ) & Equation 10\end{matrix}$$

As shown in equations 9 and 10, a probability P (y|x) for a Bayesian neural network in which latent codes Z are sampled according to a conditional distribution is expressed as an integral of the probability of latent codes P(Z) multiplicatively combined with an integral across the set of weights for a probability of an output y given an input x and a set of weights W, wherein the set of weights W is further determined as a probability given sampled latent codes Z. As expressed in equation 9, the conditional distribution over the weights depends on one or more units of the neural network, enabling the latent units to represent neural networks in which the units are correlated or otherwise connected.

Posterior inference for the expected weight distribution and the indirect control parameters may be performed by a variety of techniques, including Markov Chain Monte Carlo (MCMC), Gibbs-Sampling, Hamiltonian Monte-Carlo and variants, Sequential Monte Carlo and Importance Sampling, Variational Inference, Expectation Propagation, Moment Matching, and varients thereof In general, these techniques may be used to update the expected weight distribution according to how a modified weight distribution may improve an error in the model's output y. In effect, the posterior inference provides a means for identifying an updated expected weight distribution. Subsequently, the updated expected weight distribution may be propagated to adjustments in the indirect parameters c for the indirect network 220 that generate the expected weight distribution.

As previously discussed in conjunction with FIG. 4B, the indirect network 220 aids in the generation of transfer learning for different tasks. Since the indirect network 220 predicts general expected characteristics of a network, the parameters for the indirect network may be used as initial expected parameters for training additional direct networks for different tasks. In this example, the indirect network 220 may be used to initialize the weights for another direct network 200. As another example, the domain of a task or data set may be specified as a state variable, either with or without latent control inputs. This permits the indirect network 220 to be re-used for similar types of data and tasks in transfer learning by re-using the indirect network trained for an initial task. When training for additional types of tasks or domains, the modified control input may permit effective and rapid learning of additional domains because the training for the new domain may only require learning the differences from the prior domain while re-using the previously-learned aspects of the general data as reflected in the trained indirect parameters ε. In addition, the control inputs z may define known properties or parameters of the environment in which the direct network 200 is applied, and changes to those properties may be used to learn other data sets having other properties by designating the properties of the other data sets when learning the new data sets.

Such a control input zₛ may be a vector describing the relatedness of tasks. For many purposes that can be an embedding of task in some space. For example, when trying to classify animals we may have a vector containing a class-label for quadrupeds in general and another entry for the type of quadruped. In this case, dogs may be encoded as [1,0] and cats as [1,1] if both are quadrupeds and differ in their substructure. The indirect network 220 can describe shared information through the quadruped label “1” at the beginning of that vector and can model differences in the second part of the vector. Another example is weather prediction, where the control input z can be given by time of year (month, day, time, and so forth) and geographical location of the location we care to predict at. More generally, zₛ can also be a learned vector without knowing the appropriate control inputs a priori, provided that they can be shared between tasks. Explicitly, zₛ can also be predicted from the direct input x. An example of this is images taken from a camera with different weather conditions and a network predicting the appropriate control input z to ensure that the indirect network 220 instantiates a weather-appropriate direct network for the relevant predictive task.

In other examples, the indirect network 220 is jointly trained with multiple direct networks for different tasks, permitting the indirect network to learn global states and more general ‘rules’ for the direct networks and reflect an underlying or joint layer for the direct networks that may then be individual direct weights for individual direct networks for individual tasks. In this example, one of the indirect inputs zₛ may specify the direct network (e.g., relating to a particular task) for the indirect network 220 applied (known parameters would be classes as above or geographical location or other covariates related to the process at hand). An example of this may be instantiated as a predictive task across cities where a company may operate. If the predictive task relates to properties of cities, such as a spatiotemporal supply and demand prediction for a ridesharing platform does, one can utilize the indirect network 220 by deploying it across cities jointly and using the different city-specific variables as inputs to improve local instances of the forecasting model. City-specific inputs may be related to population density, size, traffic conditions, legal requirements and other variables describing information related to the forecasting task.

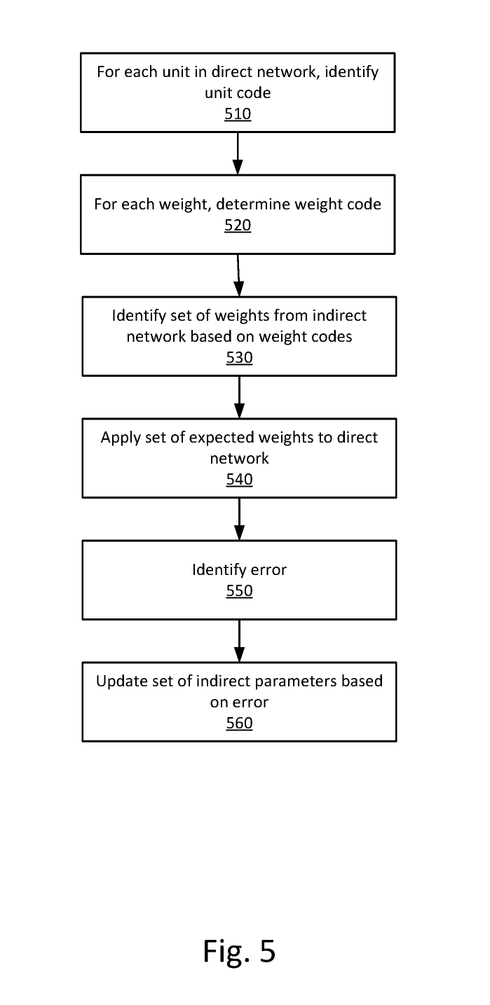

FIG. 5 is a flow diagram of a method for generating weights for a direct network using weight codes of the direct network, in accordance with an embodiment. In various embodiments, the method may include different and/or additional steps, and the steps may be performed in different orders than those described in conjunction with FIG. 5.

A direct network 200 includes one or more layers of units connected by weights. A system training the direct network 200 determines 510 a unit code for each unit in the direct network. In one embodiment, the unit code is based at least in part on a structural position of the corresponding unit in the direct network 200. For example, the unit code is a fixed function of a layer and index of the corresponding unit. In another example, the unit code is a latent representation. The system determines 520 a weight code for each weight in the direct network 200 based on unit codes associated with units connected by the weight. For example, the weight code is a concatenation of unit codes associated with units connected by the weight. The system identifies 530 a set of expected weights from the indirect network 220. The indirect network 220 generates the set of expected weights for the direct network 200 by applying a set of indirect parameters to the determined weight codes.

The system applies 540 the set of expected weights to the direct network 200. Based on the applied weights, the system 550 identifies an error between an expected output of the direct network 200 and the output generated from the direct network based on one or more inputs. In one embodiment, error is identified as using an error function. Based on the identified error, the system updates 560 the set of indirect parameters ε for the indirect network 220.

During training, in one embodiment the indirect parameters ε for the indirect network 220 and the set of weights W of the direct network 200 are alternately updated. Responsive to the set of indirect parameters ε being updated 570 for the indirect network 220, the system identifies an updated set of expected weights W for the direct network 200 and applies the updated set of expected weights to the direct network. The system identifies an error between an expected output of the direct network 200 and the output generated from the direct network using the updated set of expected weights. In one embodiment, the indirect parameters ε and the set of weights W are alternately updated for a set number of iterations.

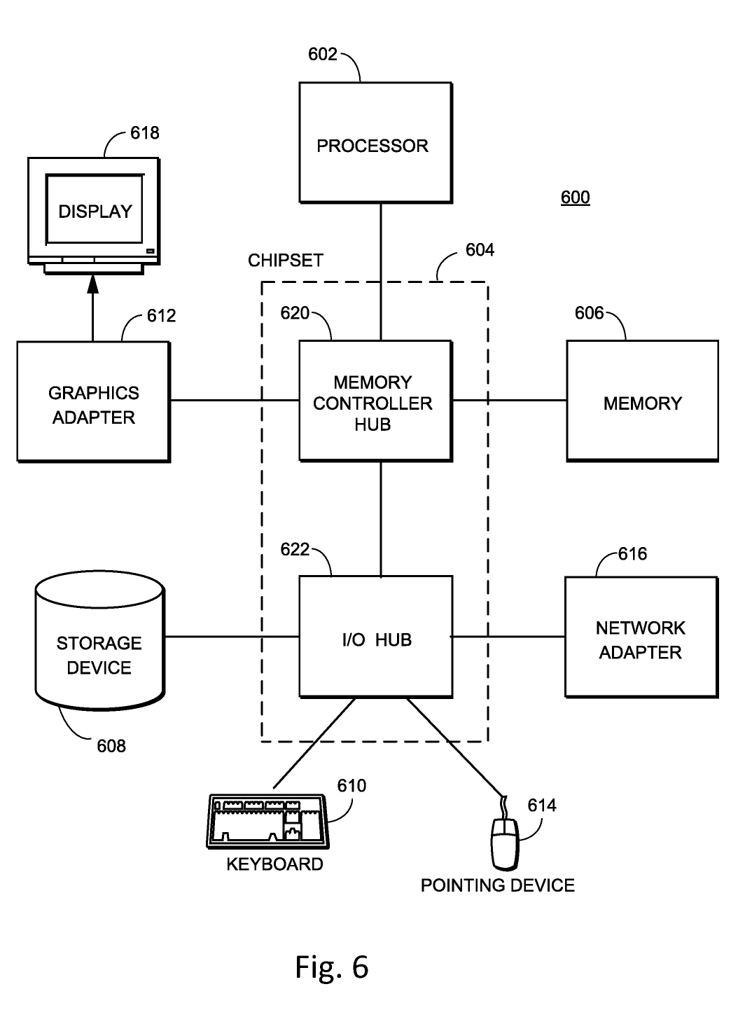

FIG. 6 is a high-level block diagram illustrating physical components of a computer 600 used to train or apply computer models such as those including a direct and indirect network as discussed herein. Illustrated are at least one processor 602 coupled to a chipset 604. Also coupled to the chipset 604 are a memory 606, a storage device 608, a graphics adapter 612, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The graphics adapter 612 displays images and other information on the display 618. The network adapter 616 couples the computer 600 to a local or wide area network.

As is known in the art, a computer 600 can have different and/or other components than those shown in FIG. 6. In addition, the computer 600 can lack certain illustrated components. In one embodiment, a computer 600, such as a host or smartphone, may lack a graphics adapter 612, and/or display 618, as well as a keyboard or external pointing device. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
for each unit in a direct network, identifying a unit code;
for each weight in a set of weights of the direct network, determining a weight code, the weight code based on unit codes associated with units connected by the weight;
identifying a set of expected weights from an indirect network that generates the expected weights for the set of weights by applying a set of indirect parameters to the determined weight codes;
applying the set of expected weights of the direct network to an input to generate an output from the set of expected weights applied to the input;
identifying an error between an expected output and the output generated from the direct network; and
updating the set of indirect parameters based on the error.

2. The method of claim 1, wherein determining a weight code further comprises performing a concatenation of unit codes associated with units connected by the weight.

3. The method of claim 1, wherein unit codes are based at least in part on a structural position of the unit in the direct network.

4. The method of claim 1, wherein unit codes are a fixed function of the structural position of the corresponding unit.

5. The method of claim 1, wherein unit codes are latent codes learned based in part on the identified error.

6. The method of claim 1, wherein determining a weight code further comprises performing a concatenation of unit codes associated with units connected by the weight and a global latent state variable.

7. The method of claim 1, wherein one or more of the unit codes, the weight codes, a global latent state variable, the indirect parameters, and the expected weights from the indirect network are probabilistic distributions.

8. The method of claim 7, wherein the probabilistic distributions are Bayesian.

9. The method of claim 1, wherein the indirect network is a parametric model.

10. A non-transitory, computer-readable medium comprising computer-executable instructions that, when executed by a processor, cause the processor to perform steps comprising:
for each unit in a direct network, identifying a unit code;
for each weight in a set of weights of the direct network, determining a weight code, the weight code based on unit codes associated with units connected by the weight;
identifying a set of expected weights from an indirect network that generates the expected weights for the set of weights by applying a set of indirect parameters to the determined weight codes;
applying the set of expected weights of the direct network to an input to generate an output from the set of expected weights applied to the input;
identifying an error between an expected output and the output generated from the direct network; and
updating the set of indirect parameters based on the error.

11. The computer-readable medium of claim 10, wherein determining a weight code further comprises performing a concatenation of unit codes associated with units connected by the weight.

12. The computer-readable medium of claim 10, wherein unit codes are based at least in part on a structural position of the unit in the direct network.

13. The computer-readable medium of claim 10, wherein unit codes are a fixed function of the structural position of the corresponding unit.

14. The computer-readable medium of claim 10, wherein unit codes are latent codes learned based in part on the identified error.

15. The computer-readable medium of claim 10, wherein determining a weight code further comprises performing a concatenation of unit codes associated with units connected by the weight and a global latent state variable.

16. The computer-readable medium of claim 10, wherein one or more of the unit codes, the weight codes, a global latent state variable, the indirect parameters, and the expected weights from the indirect network are probabilistic distributions.

17. The computer-readable medium of claim 16, wherein the probabilistic distributions are Bayesian.

18. The computer-readable medium of claim 10, wherein the indirect network is a parametric model.

19. A system comprising:
a processor; and
a non-transitory, computer-readable medium comprising computer-executable instructions that, when executed by a processor, cause the processor to perform steps comprising:
for each unit in a direct network, identifying a unit code;
for each weight in a set of weights of the direct network, determining a weight code, the weight code based on unit codes associated with units connected by the weight;
identifying a set of expected weights from an indirect network that generates the expected weights for the set of weights by applying a set of indirect parameters to the determined weight codes;
applying the set of expected weights of the direct network to an input to generate an output from the set of expected weights applied to the input;
identifying an error between an expected output and the output generated from the direct network; and
updating the set of indirect parameters based on the error.

20. The system of claim 19, wherein determining a weight code further comprises performing a concatenation of unit codes associated with units connected by the weight.
